(19) United States
(12) Patent Application Publication
(10) Pub. No.: US 2013/0232877 A1
(43) Pub. Date: Sep. 12, 2013

(54) HOUSEHOLD APPLIANCE WITH DOOR

(71) Applicant: MIELE & CIE. KG, Guetersloh (DE)

(72) Inventor: Stefan Tiekoetter, Bielefeld (DE)

(73) Assignee: MIELE & CIE. KG, Guetersloh (DE)

(21) Appl. No.: 13/786,622

(22) Filed: Mar. 6, 2013

(30) Foreign Application Priority Data
Mar. 7, 2012 (EP) 12 401 038.0

(51) Int. Cl. E05F 15/00; E05F 15/20

(52) U.S. Cl. CPC E05F 15/0004; E05F 15/20
USPC 49/138; 49/506

(57) ABSTRACT

A household appliance includes a treatment space and a door that is pivotable about a horizontally running axis so as to close the treatment space. The door includes a door spring configured to slow down a movement of the door when it is being pivoted down. A sensor is configured to monitor a functionality of the door spring. A deceleration device is configured to be activated in the event of a failure of the door spring as recognized by the sensor and to slow down movement of the door when it is being pivoted down.

### CROSS REFERENCE TO RELATED APPLICATIONS

This application claims priority to European Patent Application No. EP 12 401 038.0, filed Mar. 7, 2012, which is hereby incorporated by reference herein in its entirety.

### FIELD

The present invention relates to a household appliance having a door provided with a door spring.

### BACKGROUND

Household appliances of the aforementioned, in other words generic, type are known per se from the prior art. They have a door configured to be pivotable about a horizontal axis, by means of which an opening to the treatment space can be closed.

Generally, these doors are hinged on the lower side in order to allow a drop-down movement. Frequently, the household appliance doors are spring-loaded, in order to slow down or damp the door, in particular when it is being pivoted down. Typically, door springs are used for this purpose and, at one end, are optionally arranged with the interposition of a cable pull on the door and, on the other end, on the machine base. One or more door springs may be used depending on the configuration of the household appliance. In the case of two door springs, a first door spring is preferably used on the left-hand side of the door and a second door spring is used on the right-hand side of the door. The described springs are often configured as coil springs.

Moreover, a device is known, for example, from DE4013571A1 for matching or readjusting the springs used for damping to the weight of the household appliance doors. This is advantageous as the superstructural parts used for aesthetic reasons, such as decorative panels, have a different weight depending on the material and shape. The weight of the decorative panel therefore has a substantial influence on the opening and closing behaviour of the household appliance door.

Devices for an automatic door opening in dishwashers are furthermore known, for example, from WO 2009132813 A1. In particular, a sensor, which detects a force acting on the decorative panel, is used therein to detect an opening intention.

The use of the described door springs has proven successful in everyday practice. Nevertheless, there is a need for improvement, in particular with regard to increased operating safety.

In the known household appliances, breaking of the door spring is not recognised, nor is an uncontrolled pivoting open of the household appliance door avoided. In addition to the breaking, faulty or absent readjustment of the springs can lead to hazards.

If the door spring breaks, this leads to the door dropping down unbraked. This is a substantial safety risk as the door falls unbraked into the completely opened position during opening, which is a hazard for the user, as he could be hit and injured by the door falling down unbraked. A household appliance door which falls down unbraked is a particular danger for children who may be in the vicinity of the appliance. This danger is particularly great when the household appliance door has a particularly high weight because of a decorative panel attached to the front. A considerable potential for injury, particularly for children, exists, in particular owing to automatic opening mechanisms.

Apart from the danger of injury, there is also the possibility of additional damage to the household appliance, for example by breaking the hinge, which can require extensive repairs.

### SUMMARY

In an embodiment, the present invention provides a household appliance including a treatment space and a door that is pivotable about a horizontally running axis so as to close the treatment space. The door includes a door spring configured to slow down a movement of the door when it is being pivoted down. A sensor is configured to monitor a functionality of the door spring. A deceleration device is configured to be activated in the event of a failure of the door spring as recognized by the sensor and to slow down movement of the door when it is being pivoted down.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic side view of the door region of a household appliance according to the prior art;

FIG. 2 shows a schematic side view of the door region of a household appliance according to an embodiment of the invention;

FIG. 3 shows a schematic view of the inclination sensor;

FIG. 4 shows output signals when opening the door with an intact spring;

FIG. 5 shows output signals when opening the door with a broken spring;

FIG. 6 shows output signals when the spring breaks; and

FIG. 7 shows a schematic side view of the door region of a household appliance according to the invention.

### DETAILED DESCRIPTION

An aspect of the invention is to improve a household appliance of the type mentioned at the outset in such a way that increased operating safety is provided with regard to the door springs used.

The household appliance according to an embodiment of the invention has a door, which can be pivoted about a horizontally running axis, to close an opening of a treatment space. The door is provided with at least one door spring, which is used to slow down the movement of the door when it is being pivoted down. Moreover, the household appliance has a sensor, with which the functionality of the door spring can be monitored. By monitoring of the functionality by means of the sensor, it can therefore be recognised, in particular, whether the door spring is functioning properly or whether a failure of the door spring is present, i.e. a malfunction of the door spring, for example a broken door spring, or at least an insufficient braking effect by means of the door spring.

The household appliance moreover comprises an additional deceleration means, which is activated in the event of a failure of the door spring recognised by the sensor and is suitable for slowing down the movement of the door when it is being pivoted down. The deceleration means acts on the door or the door hinge thereof in such a way that a free, i.e. unbraked, pivoting down of the door is avoided.

The additional deceleration means is preferably only activated precisely when a failure of the door spring has been recognised. In order to be able to immediately stop the pivoting movement of the door, the activation takes place here directly, as soon as the failure of the door spring has been recognised.

The household appliance advantageously has an appliance controller for this purpose, which evaluates the signals detected by the sensor and draws conclusions with the aid of the signals and the evaluation thereof about the functionality of the door spring, i.e. determines whether the door spring is functioning properly or whether a malfunction of the door spring is present. On recognising a malfunction or a failure of the door spring, the appliance controller activates the deceleration means.

The deceleration means is preferably configured as an electromagnetically actuated brake. This may, for example, act on the hinge by frictional engagement by means of a brake block and thereby prevent the pivoting movement. The advantage in this embodiment is the particularly short reaction time of the deceleration means. Instead of an electromagnetically actuated brake, the use of a centrifugal brake or a wedge brake or another deceleration means with positive or frictional engagement, which has an analogous functionality, is also conceivable, however.

The sensor is preferably configured in such a way that time changes to the angle of inclination of the door can be detected. It can thus be determined using the signals detected by the sensor, at what speed and what acceleration the pivoting movement of the door takes place, i.e. how fast the door is opened. The detected signals are compared with predetermined reference values, which are assigned to a proper pivoting movement of the door, braked by an intact door spring. The reference values are preferably input into the appliance controller when setting up the household appliance and adjusting the correct prestressing of the door spring, or read automatically by said appliance controller by pivoting the door open and closed.

According to a particularly advantageous embodiment, the sensor is capable of measuring signals in three mutually independent spatial directions. This sensor is therefore a three-dimensionally measuring sensor, the three measuring directions preferably being orthogonal with respect to one another.

The sensor is arranged and configured here in such a way that vibrations of the household appliance door and/or acoustic pulses can be detected. If the door spring breaks when the door is being pivoted open, the spring strikes, for example, against the body, the hinge or other components of the household appliance. In this case, vibrations and/or acoustic pulses are produced, which can be detected by the sensor. Since the sensor detects signals from three mutually independent spatial directions, the latter is configured in such a way that the spatial direction of the source of the vibrations and/or acoustic pulses detected can be determined in relation to the sensor. The source of the signals can thus be pinpointed and a broken spring can be identified thereby with great reliability. The sensor or the appliance controller is therefore in capable of reliably distinguishing signals produced by a breaking of the spring from interference signals, which originate from another source. The sensor preferably also detects frequencies in the range from 1 to 4 kHz, which can be assigned to a stop signal of a broken spring, and rules out frequencies from frequency ranges located outside, at least partly. This further increases the reliability when identifying a breaking of a door spring.

It is furthermore advantageous that the sensor is a monolithic element. Thus, less cabling and assembly outlay also accrue synergistically than would be the case when using two or more sensors. An interlinking of a plurality of single-axis acceleration sensors would, however, also be conceivable, but would be associated with extra outlay during assembly.

The inclination sensor is preferably a triple-axis acceleration sensor. Sensors of this type are also called XYZ-acceleration sensors. A sensor of this type measures accelerations, a vibration being proportional to the acceleration. A possible measuring principle of a sensor of this type is that principle, according to which the sensor capacitively measures the deflection of a reference mass. In this case, the deflection of the reference mass is proportional to the acceleration. Sensors of this type can be configured as a microelectromechanical system (MEMS). Advantageously, accelerations can be measured precisely using a sensor of this type, with a simultaneously fully integrated mode of construction, low costs and small installation space. The inclination sensor may, however, also be configured as a triple-axis vibration sensor or the like. It is decisive that it is capable of measuring signals in three mutually independent spatial directions.

The advantage of the inclination sensor is the low assembly outlay, as the sensor can, for example, be positioned directly on the control electronics. A functionally reliable system results with simultaneously economical assembly.

According to a particular configuration of the invention, the inclination sensor is preferably arranged in the cover panel, as a component of the appliance controller. Various configurations are conceivable for the arrangement of the inclination sensor. In this case, the inclination sensor may, in particular, be carried by an electronic system. The sensor can preferably be carried by the control circuit board, which is arranged within the appliance controller in the cover panel. A further preferable embodiment is the arrangement of the sensor on the display or operating circuit board, within the display and operating controller. Other arrangements of the inclination sensor are also conceivable. In the case of an integrated or fully integrated household appliance, the sensor is preferably mechanically decoupled here from the decorative panel. This means that no direct operative connection exists between the decorative panel and sensor. The sensor is therefore specifically not fastened to the decorative panel, like sensors known from the prior art, but rather is spaced apart therefrom. Signals acting on the decorative panel, for example body noise, are therefore advantageously not directly transmitted to the sensor. This reduces the sensitivity to interference signals.

The malfunction determined, for example the breaking of the door spring, can be indicated to the user of the household appliance by means of a visual and/or acoustic warning signal, for example as a warning light or warning sound. The user is thus prewarned and will not be surprised by an appliance door falling down unbraked when opening the door. If the door is still in the closed position when the malfunction is recognised, an automatic door-opening device is preferably blocked, i.e. the automatic opening mechanism does not occur. The user can then be given the opportunity of opening the appliance door in a controlled manner, which minimises the safety risk already described, so the operating safety for using the door springs can be significantly increased.

According to a preferred configuration of the invention, the voltage of the sensor is supplied before the main switch of the household appliance. It is advantageous here that the monitoring of the door spring is also made possible when the household appliance is switched off According to a further special configuration of the invention, the voltage of the deceleration means is supplied before the main switch of the household appliance. This advantageously allows an activation of the deceleration means even when the household appliance is switched off.

In an embodiment, the present invention also provides a method in which signals are measured by means of a sensor, the signals are evaluated and a conclusion is drawn, using the signals, about the functionality of the door spring. When a malfunction of the door spring is recognised, a fault message or a warning signal is emitted. Alternatively or in addition, an automatic door-opening device is blocked or a deceleration means is activated to slow down the movement of the door when it is being pivoted down.

The invention is suitable for all types of household appliances, in which a door is pivoted open about a horizontal axis, in particular for integrated or fully integrated household appliances, in which the weight of the decorative panel increases the danger of injury. In particular, the invention is suitable for ovens, steam cookers, microwave appliances, refrigeration units and dishwashers.

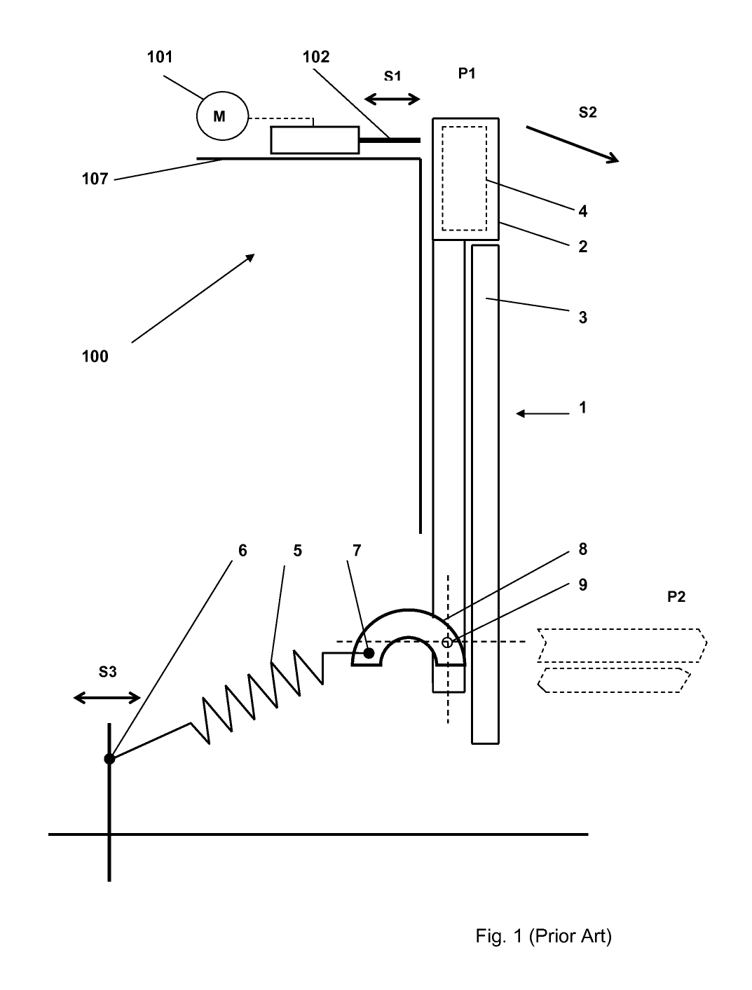

FIG. 1 schematically shows the door region of a prior art dishwasher 100 together with an assembled decorative panel 3. Further essential components of the household appliance door 1 are the appliance controller 4 having the operating cover panel 2. In this embodiment, a partly integrated dishwasher is shown by way of example, in which a part region of the front is covered by a decorative panel 3 and an operating cover panel 2 is also visible when the appliance 100 is closed, i.e. in the closed position P1.

The household appliance door 1 is furthermore connected by a hinge 8 to the appliance 100, which hinge allows a pivoting movement, proceeding from the closed position P1 of the door 1 into the opened position P2 about the pivot point 9. Moreover, the hinge 8 has a mounting point 7 on the door side, in which a door spring 5 is fastened, said door spring being hooked in the mounting point 6 on the appliance side. The purpose of the door spring 5 is to slow down the door 1, in particular during opening, so that it does not fall into the opened position P2 following the force of gravity. By means of a spindle mechanism, the position of the mounting point 6 on the appliance side along the path S3, and therefore the prestressing of the door spring 5, can be varied, and the force of the door spring 5, which is often configured as a coil tension spring, can thus be matched to the door weight. A correctly set adjustment of the door spring ensures that the door remains in any angle position and does not automatically open further or close again.

Located above the treatment space 107 is a device for automatic opening, consisting of a motor 101, which drives a gear rack 102 and displaces it horizontally by the path S1. The door is thus pressed into a slightly opened position in the first phase of automatic door opening. The spring 5 normally slows down the drop-down movement S2 here, i.e. acts against the gravitational force of the door 1, which otherwise would bring about a complete drop down. A breaking of the spring can have serious consequences here as the door swings open in an uncontrolled manner.

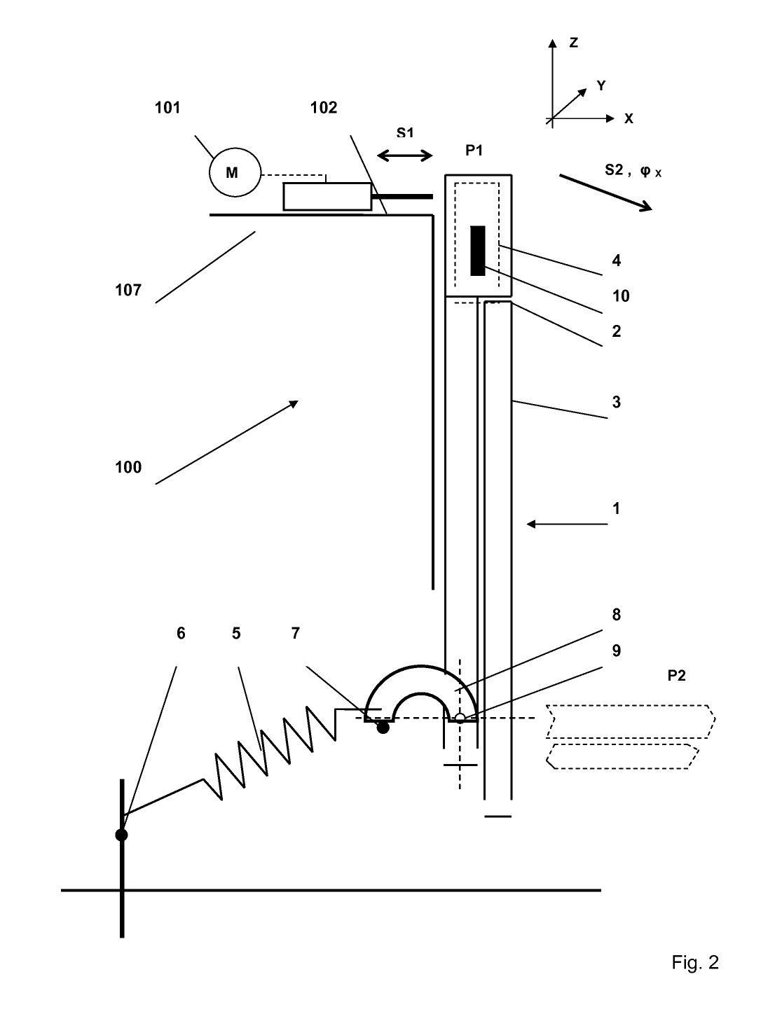

The door region of a dishwasher 100 is shown schematically in FIG. 2. In addition to the features already described, the inclination sensor 10 is shown here according to the invention, preferably arranged in the cover panel 2, as a component of the appliance controller 4. Other arrangements of the inclination sensor are also conceivable. The inclination sensor 10 is preferably a triple-axis sensor, in particular a triple-axis acceleration sensor. The latter measures signals in the three orthogonal spatial directions X, Y, Z shown in FIG. 2.

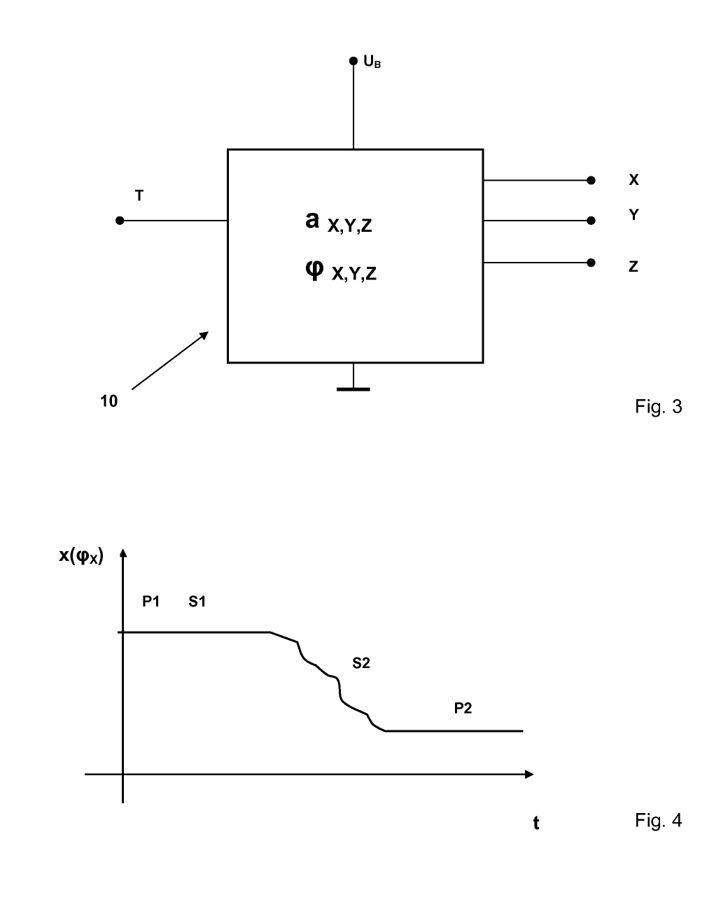

A schematic depiction of the inclination sensor 10 is to be found in FIG. 3. In addition to the three signal outputs for the three spatial directions X, Y and Z, there is also a test input T to test the sensor. An amplitude-invariant signal or rest signal is tapped at the three signal outputs X, Y and Z, as long as the sensor 10 is not inclined about the three spatial angles φₓ, φ_{y} or φ_{z}, or as long as no accelerations, aₓ, a_{y} or a_{z} act on the sensor 10. If one of the parameters mentioned changes, a different signal is emitted at the outputs X, Y and Z. The three signals of the sensor 10 are read in and evaluated by means of a control computer (not shown) in the appliance controller 4.

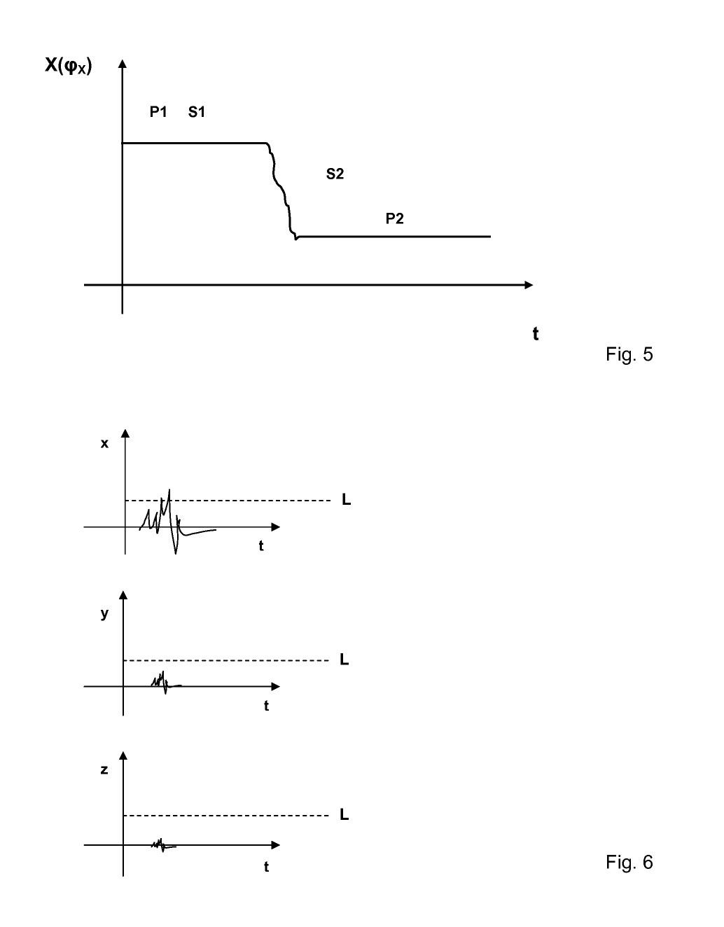

If the spring is intact and correctly adjusted, the signal course during door opening at the signal output X is as shown by way of example in FIG. 5. FIG. 4 shows the signals of the sensor for monitoring the opening movement. If the household appliance door is in the closed position P1, the signal at the signal output X has, for example, an amplitude-invariant high first level. This only changes when the gear rack driven by the motor covers the path S1 and therefore pivots open the door. In the second phase of door opening, the signal level at the signal output X continuously falls further during the opening path S2, until the door is completely pivoted open into position P2 manually by the user. In this position, the signal at the signal output X has a second level that is lower in comparison to the first level. If the door spring 5 is intact, the opening process is completed in a more or less damped manner depending on the adjusted spring tension. The pitch or gradient of the signal is relatively low in this case.

If the door spring 5 is faulty, in other words broken or incorrectly or poorly adjusted, the door 1 undergoes a greater acceleration aₓ and this is shown by a higher pitch or a higher gradient in the signal of the signal output X. A corresponding signal course is shown by way of example in FIG. 5.

The pitch of the signal or the gradient in the signal of the outputs X, Y, Z is a measure of the inclination speed of the household appliance door 1. The inclination speed is in turn determined by the prestressing of the door spring 5 and an intact spring system. Reference parameters for the gradient are preferably input into the appliance controller 4 when setting up the household appliance 100 and adjusting the correct prestressing of the door spring 5, or are automatically read in thereby by pivoting the door 1 open and shut.

If a spring breaks, it can also preferably be immediately detected by the acceleration sensor 10. The XYZ-acceleration sensor 10 therefore provides the possibility, as a result of its spatial orientation, of also directly recognising the breaking of the door spring 5. The household appliance door 1 and the integrated acceleration sensor 10 are mechanically, and therefore also acoustically, connected to the door spring 5 by the door hinge 8. In the event of a break, the spring 5 strikes against the body of the household appliance 100 or directly against the hinge 8, which is propagated as an acoustic pulse and therefore also as an acceleration up to the XYZ-acceleration sensor 10. Depending on the spatial orientation of the acoustic pulse, the signal outputs of the sensor 10 supply a different level of signal intensity, so a spring break can be identified and pinpointed.

FIG. 6 shows the signal outputs for a spring break by way of example. In this case, one axis in each case measures a signal in one of the spatial directions X, Y, Z. The respective signal level is plotted over the time in FIG. 6. A value L shown by dashed lines in FIG. 6, which can also be different depending on the spatial direction, can be used, for example, as the threshold value, the exceeding of which is evaluated by the appliance controller 4. If at least one threshold value is exceeded, the appliance controller 4 infers that a spring has broken. By evaluating all three signals, for example by testing which of the three threshold values, or for which of the three spatial directions, the threshold value has been exceeded, the source of the signals can be pinpointed by the appliance controller 4. Depending on the result of this pinpointing, the appliance controller 4 determines whether the signals are to be attributed to a breaking of the spring 5 or to another cause.

If a door spring break is recognised, the appliance controller 4 ensures that a fault message is output, in particular a visual and/or acoustic warning signal. Alternatively or additionally, the appliance controller can, for example, block any automatic door opening mechanisms that may be present, so the door remains closed, or activate a deceleration means for slowing down the movement of the door 1 when it is being pivoted down.

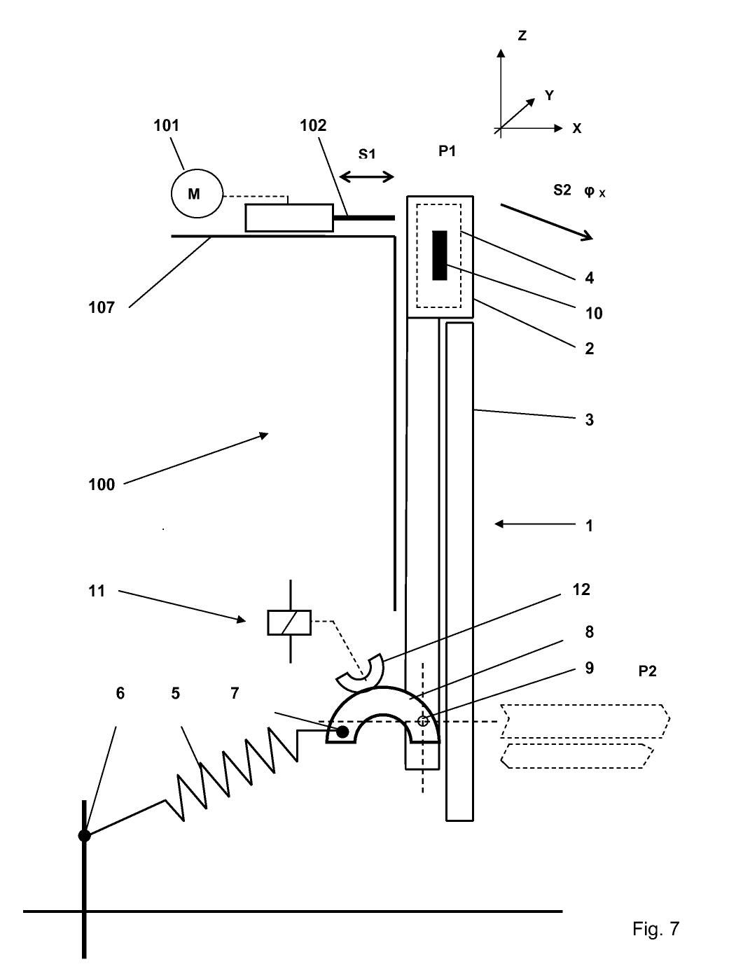

FIG. 7 schematically shows the door region of a household appliance 100 according to the invention. The latter, in particular, comprises a deceleration means 11. The latter is, in the present case, configured as an electromagnetically actuated brake, which acts directly by frictional engagement on the hinge 8 by means of a brake block 12. As a result, the downward movement of the door 1 can be reliably and quickly stopped.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

1. A household appliance comprising:
a treatment space;
a door that is pivotable about a horizontally running axis so as to close the treatment space, the door including a door spring configured to slow down a movement of the door when it is being pivoted down;
a sensor configured to monitor a functionality of the door spring; and
a deceleration device configured to be activated in the event of a failure of the door spring as recognized by the sensor and to slow down movement of the door when it is being pivoted down.

2. The household appliance according to claim 1, wherein the household appliance is a dishwasher, steam cooker or oven.

3. The household appliance according to claim 1, wherein the sensor is configured to detect time changes in an angle of inclination of the door.

4. The household appliance according to claim 3, wherein the sensor is configured to detect signals from three independent spatial directions.

5. The household appliance according to claim 1, wherein the sensor is configured to detect at least one of vibrations of the appliance or acoustic pulses that are triggered by a breaking of the door spring.

6. The household appliance according to claim 5, wherein the sensor is configured to determine a spatial direction of a source of the detected at least one of vibrations or acoustic pulses in relation to the sensor.

7. The household appliance according to claim 1, further comprising an appliance controller configured to evaluate signals detected by the sensor.

8. The household appliance according to claim 1, wherein the sensor is mechanically connected by the door hinge to the door spring.

9. The household appliance according to claim 1, wherein the sensor includes one or more interlinked single-axis acceleration sensors.

10. The household appliance according to claim 1, wherein the sensor is a triple-axis sensor.

11. The household appliance according to claim 10, wherein the sensor is a triple-axis acceleration sensor or a triple-axis vibration sensor.

12. The household appliance according to claim 1, wherein the deceleration device acts by frictional engagement on the hinge.

13. The household appliance according to claim 1, wherein the deceleration device includes an electromagnetically actuable brake.

14. The household appliance according to claim 1, wherein the deceleration device includes a centrifugal brake or a wedge brake.

15. The household appliance according to claim 1, wherein a voltage of at least one of the sensor or the deceleration device is supplied before a main switch of the household appliance.

16. A method for operating a household appliance including a door that is pivotable about a horizontally running axis so as to close a treatment space, the door being provided with a door spring configured to slow down the movement of the door when it is being pivoted down, the method comprising:
measuring signals using a sensor;
evaluating the signals and inference about a functionality of the door spring using the signals; and
on recognition of a failure of the door spring carrying out at least one of:
emitting a fault message;
emitting a warning signal;
blocking an automatic door-opening device; or
activating a deceleration means to slow down a movement of the door when it is being pivoted down.
